(19) United States
(12) Patent Application Publication
(10) Pub. No.: US 2016/0021448 A1
(43) Pub. Date: Jan. 21, 2016

(54) MICROPHONE SYSTEM AND MICROPHONE CONTROL METHOD

(71) Applicant: Solid State System Co., Ltd., Hsinchu (TW)

(72) Inventors: Chien-Wen Peng, Hsinchu County (TW); Chao-Ping Chuang, Hsinchu County (TW)

(21) Appl. No.: 14/533,100

(22) Filed: Nov. 5, 2014

(30) Foreign Application Priority Data
Jul. 21, 2014 (TW) 103124963

(51) Int. Cl. H04R 1/08

(52) U.S. Cl. CPC H04R 1/08

(57) ABSTRACT

A microphone system includes an acoustic control unit and a microphone unit. The acoustic control unit transmits a clock signal and receives an acoustic audio signal and determines whether or not the acoustic audio signal is a valid audio data. The microphone unit receives the clock signal from the acoustic control unit and transmits the acoustic audio signal captured by the microphone unit to the acoustic control unit. Before the acoustic audio signal is determined as the valid audio data, the acoustic control unit transmits the clock signal which is turned on and off repeatedly with an ON duration and an OFF duration.

### CROSS-REFERENCE TO RELATED APPLICATION

This application claims the priority benefit of Taiwan application serial no. 103124963, filed on Jul. 21, 2014. The entirety of the above-mentioned patent application is hereby incorporated by reference herein and made a part of this specification.

### BACKGROUND OF THE INVENTION

1. Field of Invention

The present invention relates to microphone system and the control method thereof.

2. Description of Related Art

Microphone is a popular device for converting the acoustic wave into electric signal. The microphone in present stage can be divided into two types, which are analog microphone and digital microphone. The analog microphone converts the acoustic wave into analog signal for output. The digital microphone converts the acoustic wave into digital signal for output. The microphone when not specifying analog or digital in the following descriptions is referring to digital microphone as the example.

FIG. 1 is a drawing, schematically illustrating the conventional control mechanism between the microphone unit and the acoustic control unit. Referring to FIG. 1, the microphone unit 100 has two terminals, of which one terminal is for receiving clock signal, indicated by clk terminal, and another terminal is to output the acoustic audio signal, indicated by data terminal;. The acoustic control unit 102 has also two terminals for connecting to the clk terminal and the data terminal.

The conventional control mechanism uses one terminal of the acoustic control unit 102 to transmit a clock signal 104 to the microphone unit 100. The clocks of this clock signal 104 are continuously transmitted. The microphone unit 100 receives the clock signal 104 and is then woken up. After a certain period, such as 100 ms, it can reach the activated state and can transmit the acoustic audio signal 106 to the acoustic control unit 102, according to the acoustic source received by the microphone unit 102.

For the conventional control mechanism, the acoustic control unit 102 continuously transmits the clock signal 104, and the microphone unit 100 is also continuously converting the acoustic wave into the acoustic audio signal and outputs the acoustic audio signal. As a result, the microphone system continuously consumes the power. This contradicts to the effect of saving power.

### SUMMARY OF THE INVENTION

The invention provides a microphone system and control method of the microphone. The power consumption of the microphone system can be reduced.

According to an embodiment of the invention, a microphone system is provided, including an acoustic control unit and a microphone unit. The acoustic control unit transmits a clock signal and receives an acoustic audio signal, and determines whether or not the acoustic audio signal is a valid audio data. The microphone unit receives the clock signal from the acoustic control unit and transmits the acoustic audio signal captured by the microphone unit to the acoustic control unit. Before the acoustic audio signal is determined as the valid audio data, the acoustic control unit transmits the clock signal which is turned on and off repeatedly with an ON duration and an OFF duration.

In an embodiment of the invention, the acoustic control unit of the microphone system includes signal processor unit and gated clock unit. The gated clock unit is controlled by the signal processor unit, to continuously transmit the clock signal with a continuous ON duration or transmits the clock signal which is turned on and off repeatedly with an ON duration and an OFF duration. The signal processor unit also determines whether or not the acoustic audio signal is the valid audio data.

In an embodiment of the invention, a control method of microphone is provided for a control between an acoustic control unit and a microphone. The control method comprises: transmitting a clock signal to the microphone unit from the acoustic control unit; transmitting an acoustic audio signal to the acoustic control unit from the microphone unit; receiving the acoustic audio signal at the acoustic control unit, which determines whether or not the acoustic audio signal is a valid audio data; transmitting the clock signal which is turned on and off repeatedly with an ON duration and an OFF duration to the microphone unit from the acoustic control unit when the acoustic control unit determines the acoustic audio signal as not the valid audio data; and transmitting the clock signal with a continuous ON duration to the microphone unit from the acoustic control unit when the acoustic control unit determines the acoustic audio signal as the valid audio data.

In an embodiment of the invention, the acoustic control unit includes a signal processor unit and a gated clock unit. An operation between the acoustic control unit and the microphone unit comprises: transmitting the clock signal which is turned on and off repeatedly with the ON duration and the OFF duration from the gated clock unit; and controlling the gated clock unit by the signal processor unit, to transmit the clock signal with the continuous ON duration, or stop the clock signal for triggering the microphone unit to enter a sleeping state or a power-saving state. Wherein, the signal processor unit supports the operation of the gated clock unit and also determines whether or not the acoustic audio signal is the valid audio data.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a drawing, schematically illustrating the conventional control mechanism between the microphone unit and the acoustic control unit.

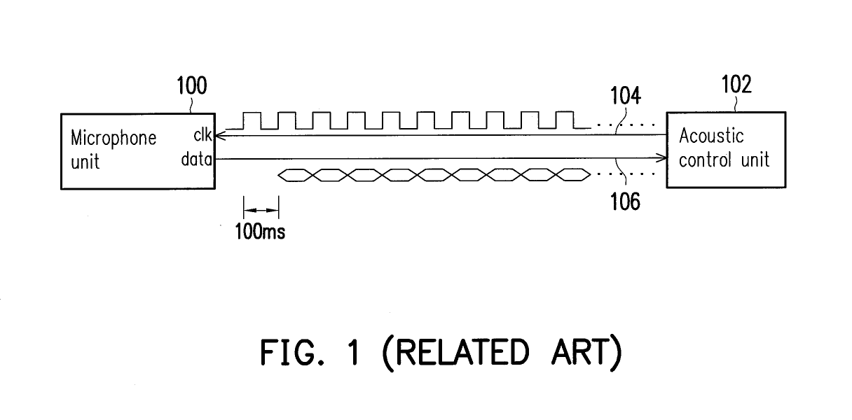

FIG. 2 is a drawing, schematically illustrating a microphone system, according to an embodiment of the invention.

FIG. 3 is a drawing, schematically illustrating a circuit structure of the acoustic control unit, according to an embodiment of the invention.

FIG. 4 is a drawing, schematically illustrating a operation mechanism for the microphone system, according to an embodiment of the invention.

FIG. 5 is a drawing, schematically illustrating the operation mechanism for the microphone system in a whole, according to an embodiment of the invention.

### DESCRIPTION OF THE EMBODIMENTS

The microphone system in the invention takes a control of the clock signal, which is not necessarily to always continuously transmit the clock signal, so the power consumption of the microphone can at least be reduced. Multiple embodiments are provided for descriptions, but the invention is not just limited to provided embodiments.

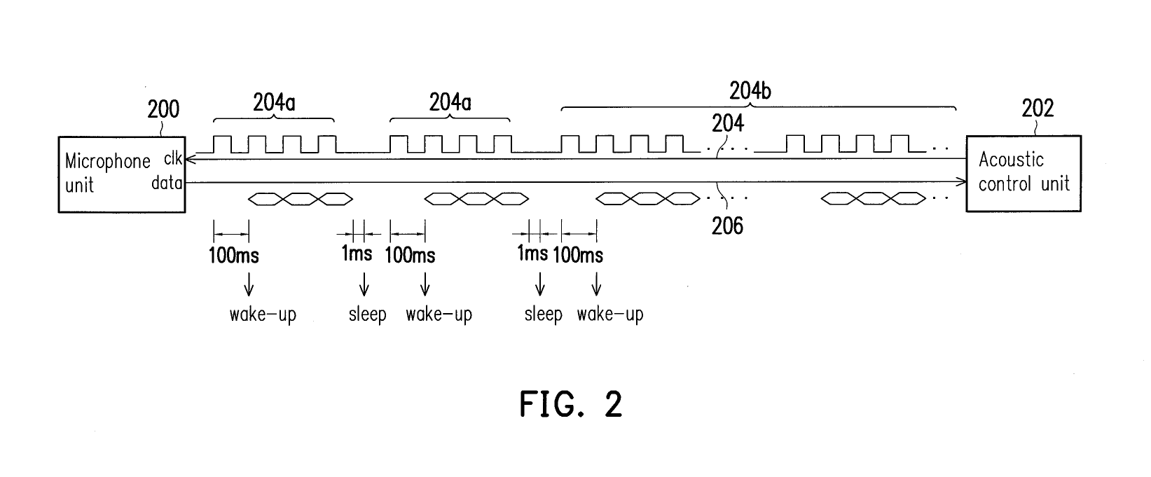

FIG. 2 is a drawing, schematically illustrating a microphone system, according to an embodiment of the invention. Referring to FIG. 2, the microphone unit 200 has two terminals, of one terminal is for receiving clock signal, indicated by clk terminal, and another terminal is for transmitting acoustic audio signal, indicated by data terminal. The acoustic control unit 202 has also two terminals for connecting to the clk terminal and the data terminal of the microphone unit 200. In an embodiment, the system at the initial state is at the power-saving state. The acoustic control unit 202 may transmit a clock signal with limited length to wake up the microphone unit 200. The clock signal 204 is not a clock continuously being transmitted but at least one clock duration 204a is periodically transmitted. In the embodiment, the number of the clock duration 204a for detection is one for the example. In the actual situation, the number of the clock duration 204a can be one or multiple for keeping on periodical detection until the acoustic audio signal is detected as the valid audio data. For the clock duration 204a, in which the valid audio data has been detected as the valid audio data, this clock duration 204a would be the last one of the clock duration(s) 204a being periodically transmitted. Generally in this operation mode, the acoustic control unit 202 transmits the clock signal which is turned on and off repeatedly with the ON duration indicated by the clock duration 204a, and the OFF duration between adjacent two clock durations 204a. When the acoustic audio signal 206 is detected and determined as the valid audio data, the operation mode of the clock signal 204 is changed to a continuous-ON clock signal. Here, the clock signal 204 changes to the form with a continuous ON duration, which is indicated as the acoustic clock duration 204b to keep on receiving the acoustic audio signal. The acoustic clock duration 204b would last until a stop condition in the application of the received audio signal is satisfied. For example, in an application of detecting a specific keyword or a key sentence, the stop condition happens when the keyword or key sentence is detected. The microphone unit 200 can be digital microphone, which is activated by a trigger of the clock signal.

In the embodiment, when one of the clock duration 204a is transmitted in each time from the acoustic control unit 202, the microphone unit 200 is woken up within a time period, such as 100 ms, and responds an acoustic audio signal 206. The acoustic control unit 202 determines whether or not the acoustic audio signal 206 is a valid audio data. The determining method can be done by various manners. For example, it can measure the energy strength or S/N ratio of the acoustic audio signal for a certain period of time. When one or both of the measurements is over a threshold, then the acoustic audio signal can be treated as the valid audio data. However, the invention is just limited to the specific manner to determine the acoustic source. In the embodiment, after the acoustic audio signal 206 corresponding to the clock duration 204a is measured and is determined not as the valid audio data, the sleeping state would remain. The acoustic control unit 202, according to the predetermined polling period, would transmit the next clock duration 204a after one period. Here, it is assumed that the valid audio data would be detected in the clock duration 204a as the last one, the clock would be changed into the mode for continuously transmitting, so the clock duration with the last one of the clock duration 204a is indicated by the acoustic clock duration 204b. For this acoustic clock duration 204b, the microphone 200 responds, like the way to respond the clock duration 204a, an acoustic audio signal 206 with a time length, and is determined by the acoustic control unit 202 as a valid audio data. Then, the clock signal 204 is continuously transmitted, indicated by continuous dots, as the acoustic clock duration 204b. The microphone 200 then continuously provides the audio data. After the acoustic clock duration 204b, the actual audio source may have no sound in a certain short period. However, the clock signal 204 is still continuously transmitted to indicate the status of the practical audio source. The microphone 200 still remains at the activated status. In general, it would continuously last until a condition in the acoustic control unit is satisfied to stop the microphone unit 200.

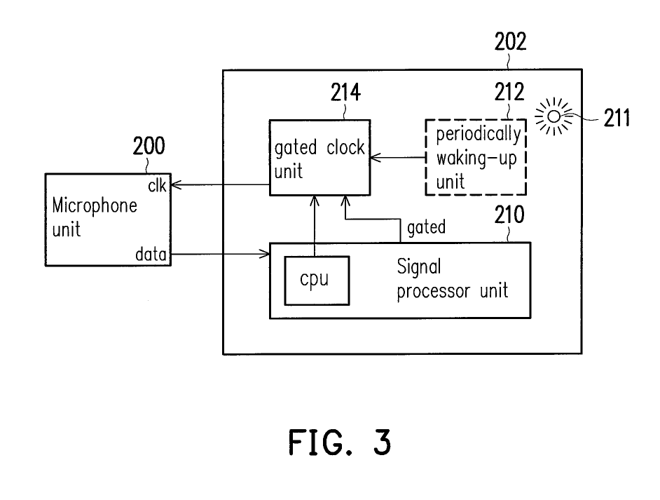

FIG. 3 is a drawing, schematically illustrating a circuit structure of the acoustic control unit, according to an embodiment of the invention. Referring to FIG. 3, the internal circuit blocks of the acoustic control unit 202 in an embodiment of the invention can include a signals processor unit 210, a periodically waking-up unit 212 and gated clock unit 214. The gated clock unit 214 may be under control of the periodically waking-up unit 212 to periodically transmit at least one clock duration 204a with a limited length, in which the last one of the clock duration 204a with valid audio data would be changed to the acoustic clock duration 204b. The implementation of the periodically waking-up unit 212 is not just limited to the provided embodiment. Any other control being able to cause the gated clock unit 214 for transmitting at least one clock duration 204a with a limited length is acceptable. The gated clock unit 214 can also be controlled by the signal processor unit 210 to continuously transmit the clock signal 204 or stop the clock signal for triggering the microphone unit 200 to enter sleeping state or power-saving state. The signal processor unit 210 includes central processing unit (CPU), which can support the whole operation for the periodically waking-up unit 212 and the gated clock unit 214 and determines whether or not the received acoustic audio signal is a valid audio data. For example, the signal processor unit 210 can control the gated of the gated clock unit 214 for outputting clock. In addition, the clock signal 204 is stopped when a condition to turn off the microphone 200 is satisfied, in which the condition may be, for example, the request by the user to turn off the microphone or no valid audio data is detected for a period of time over than a setting value.

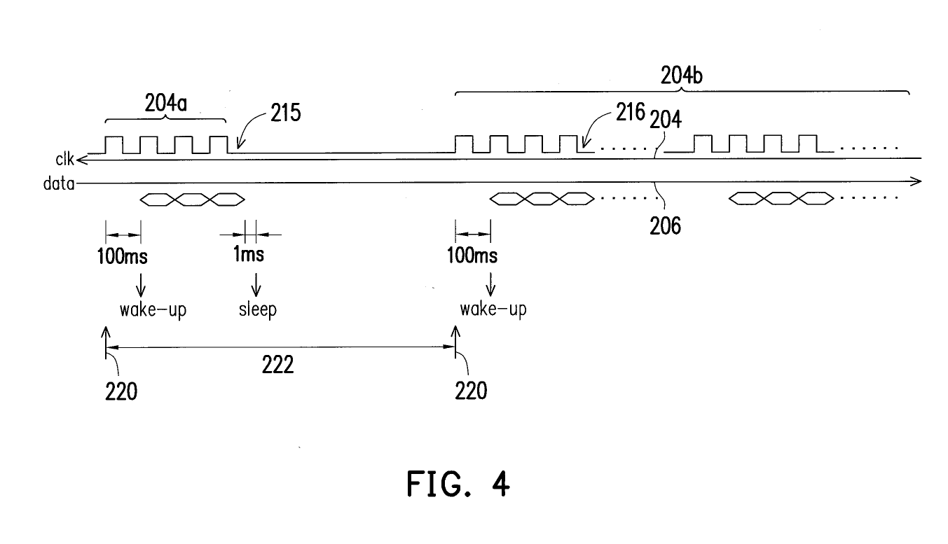

FIG. 4 is a drawing, schematically illustrating a operation mechanism for the microphone system, according to an embodiment of the invention. Referring to FIG. 4, it is the further description for the drawing in FIG. 2. The acoustic control unit 202 activates a detecting action at the predetermined polling time point 220, and then the microphone 200 is woken up. It is assumed for this clock duration 204a that the microphone 200 receives no acoustic audio signal which can be determined as the valid audio data. As a result, the clock duration 204a stops at the time point 215 without further clocks being transmitted. The microphone unit 200 then enters to the sleeping state. When the time lasts for a polling period 222 to the next polling time point 220, another clock duration 204a is transmitted. In the example, it is assumed that the valid audio data would be detected, so this clock duration 204a is changed to the acoustic clock duration 204b. The polling period 222 is the time length between adjacent two polling time points 220.

In the embodiment, the acoustic clock duration 204b is taken as the example, in which the detection result is a valid audio data, so the clock signal 204 is continuously transmitted even after the time point 216. Accordingly, the microphone 200 is also continuously transmitting the acoustic audio signal 206. In further example, a light device 211, shown in FIG. 3, can be implemented to indicate the operation status of the microphone system. For example, when the light device 211 is ON to indicate the operation status that the acoustic control unit 202 is at the status to continuously transmit clocks for the acoustic clock duration 204b. Alternative example, it can indicate the operation state that the valid audio data is still positively detected. The location of the light device 211 is not limited to the microphone 200 or the acoustic control unit 202, any location being able to indicate the operation status of the microphone is acceptable.

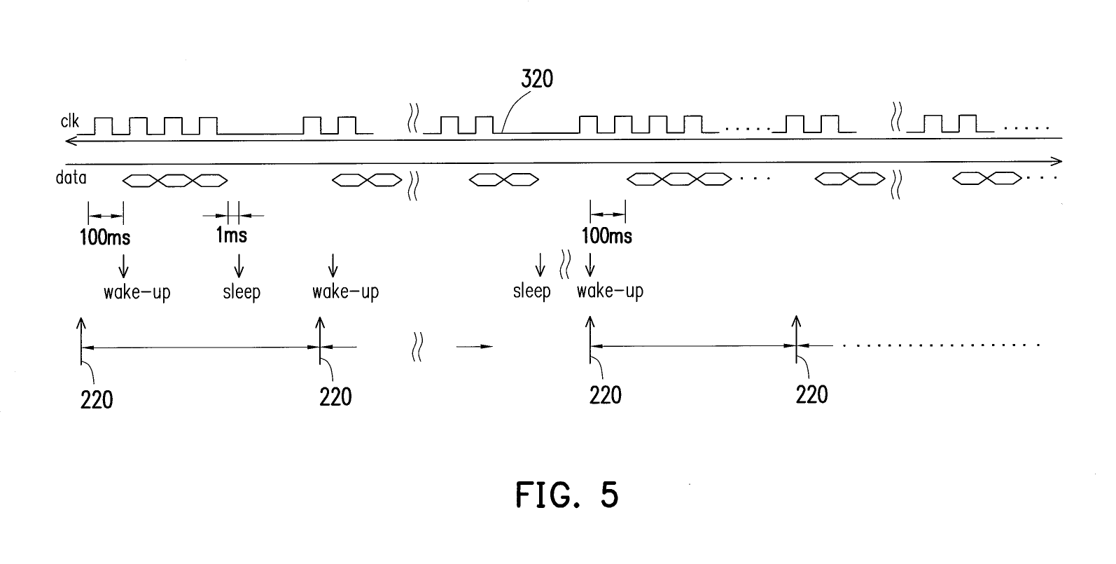

FIG. 5 is a drawing, schematically illustrating the operation mechanism for the microphone system in a whole, according to an embodiment of the invention. Referring to FIG. 5, for the situation with long term of whole operation, if the microphone unit at the initial state is at the sleeping state, the acoustic control unit 202 then starts the polling period at the polling time point 220, taking the situation in FIG. 4 as the example. Then, the detection at next polling time point 220 would successfully detect the valid audio data, in assumption, so the clock signal 204 would last continuously until the time point 320, at which time a condition to turn off the microphone 200 is satisfied. So, the acoustic control unit 202 stops the clock signal and the microphone unit 200 enters the sleeping state. In this stopping period, the acoustic control unit 202 needs no the polling period for further detection. After the time point 320, the microphone unit 200 is at the sleeping state. However, the acoustic control unit 202 may again start the polling period for detection due to system design or a request by a user, and then a next detection for valid audio data may start until the valid audio data is successfully detected, in an example. In another situation, the detection of valid audio data may continue until the acoustic control unit is turned off by the system.

In the process of embodiments for the acoustic control unit 202 to activate the microphone 200, a short period is used in each time of detection for periodically detecting existence of the valid audio data, until the valid audio data has been detected, and then the microphone 200 is activated. Thus, power consumption by the clock signal and the microphone system can be reduced and thereby the effect of saving power can be reached.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A microphone system, comprising:
an acoustic control unit, transmitting a clock signal, receiving an acoustic audio signal and determining whether or not the acoustic audio signal is a valid audio data; and
a microphone unit, receiving the clock signal from the acoustic control unit and transmitting the acoustic audio signal captured by the microphone unit to the acoustic control unit,
wherein before the acoustic audio signal is determined as the valid audio data, the acoustic control unit transmits the clock signal which is turned on and off repeatedly with an ON duration and an OFF duration.

2. The microphone system of claim 1, wherein when the acoustic audio signal is determined as the valid audio data, the acoustic control unit continuously transmits the clock signal with a continuous ON duration.

3. The microphone system of claim 1, wherein if the microphone unit does not receive the clock signal within a predetermined period, the microphone unit enters into a sleeping state or a power-saving state which does not transmit the acoustic audio signal.

4. The microphone system of claim 1, wherein the acoustic control unit includes a signal processor unit and a gated clock unit,
wherein the gated clock unit is controlled by the signal processor unit to continuously transmit the clock signal or transmit the clock signal which is turned on and off repeatedly with the ON duration and the OFF duration,
wherein the signal processor unit determines whether or not the acoustic audio signal is the valid audio data.

5. The microphone system of claim 1, wherein the microphone is a digital microphone.

6. The microphone system of claim 1, further comprising a lighting device for indicating a status of the clock signal of the microphone system.

7. A control method of microphone, used for a control between an acoustic control unit and a microphone, comprising:
transmitting a clock signal to the microphone unit from the acoustic control unit;
transmitting an acoustic audio signal to the acoustic control unit from the microphone unit;
receiving the acoustic audio signal at the acoustic control unit, which determines whether or not the acoustic audio signal is a valid audio data;
transmitting the clock signal which is turned on and off repeatedly with an ON duration and an OFF duration to the microphone unit from the acoustic control unit when the acoustic control unit determines the acoustic audio signal as not the valid audio data; and
transmitting the clock signal with a continuous ON duration to the microphone unit from the acoustic control unit when the acoustic control unit determines the acoustic audio signal as the valid audio data.

8. The control method of microphone of claim 7, wherein the acoustic control unit includes a signal processor unit and a gated clock unit, an operation between the acoustic control unit and the microphone unit comprises:
transmitting the clock signal which is turned on and off repeatedly with the ON duration and the OFF duration from the gated clock unit; and
controlling the gated clock unit by the signal processor unit, to transmit the clock signal with the continuous ON duration, or stop the clock signal for triggering the microphone unit to enter a sleeping state or a power-saving state,
wherein the signal processor unit supports the operation of the gated clock unit and also determines whether or not the acoustic audio signal is the valid audio data.

9. The control method of microphone of claim 8, wherein after the acoustic control unit stops continuously transmitting the clock signal, according to a status in use, and triggers the microphone unit to enter the sleeping state or the power-saving state, the gated clock unit again periodically transmits the clock signal with the clock duration.

10. The control method of microphone of claim 7, wherein the microphone is a digital microphone.

11. The control method of microphone of claim 7 further comprising indicating an operation status of the acoustic control unit by a light device.
